(19) United States
(12) Patent Application Publication
(10) Pub. No.: US 2007/0214924 A1
(43) Pub. Date: Sep. 20, 2007

(54) Material puller assembly

(76) Inventors: James K. Jourdan, Fond du Lac, WI (US); Ronald W. Schwilk, Oshkosh, WI (US); Jeffery J. Cysiewski, Oshkosh, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/377,411

(22) Filed: Mar. 16, 2006

(51) Int. Cl. B26D 7/02; B26D 7/06

(52) U.S. Cl. 83/206; 83/153; 83/277; 83/436.3

(57) ABSTRACT

A material puller assembly for use with a sawing machine for pulling material away from the saw cutting area includes horizontal support means for supporting material fed from an in-feed shuttle assembly, through the saw cutting area and toward the puller assembly. The puller assembly uses a first horizontal side support member along which movement of a vertically-disposed support means is provided. The vertically-disposed support means includes means for clamping a piece of material between a vertically-movable upper clamp jaw and a vertically-stationary lower clamp jaw. The vertically-disposed support means and the clamp jaws are horizontally movable along the first side support member. Rotatably suspended between the first and second side support members are a number of support rollers. At least one of the support rollers includes an axial contour matching the contour of the vertically-stationary lower clamp jaw such that the lower clamp jaw can pass over the roller.

### FIELD OF THE INVENTION

This invention relates generally to sawing machines, band saws, including vertical band saws with power tilting capabilities, and to assemblies that are used with such sawing machines and band saws to shuttle material towards and away from the saw blade cutting area. More specifically, this invention relates to a material puller assembly that is used to pull material away from the cutting blade area on the out-feed side of the sawing machine.

### BACKGROUND OF THE INVENTION

Sawing machines, including vertical band saws having tilting frames and mechanisms and controllers for changing the angle of tilt of the saw blade, are known in the art. A saw and wide sweep tilting mechanism of this general type is described and claimed in U.S. Pat. No. 6,601,494 issued to Jourdan, the disclosure of which is incorporated herein by reference. Sawing machines, including vertical band saws, having tilting frames and mechanisms are known to utilize material feed assemblies to advance or “shuttle” a length of material toward the saw blade cutting area, in the vicinity of where the advanced material is to be cut by the saw blade. The shuttle assembly typically includes a vise-like assembly that uses opposing vise jaws to grasp and move the material toward the saw blade cutting area. For purposes of this application, this can be referred to as the material “in-feed” side of the sawing machine. Once advanced, the vise clamps of the sawing machine clamp and hold the material in place during cutting.

As cutting is completed, the machine vise releases the length of the material and the shuttle vise jaws are drawn back along the material but away from the cutting blade area. The shuttle vise jaws then re-grasp the material at another point, the machine vise releases the material and the shuttle vice jaws move the material forwardly, advancing it to a point where the saw blade can make another cut. This process is repeated over and over until the remaining material is too short for the vise assembly to shuttle it towards the saw blade.

In the experience of these inventors, there can be some wasting of the remaining material to the opposite, or “out-feed,” side of the sawing machine with the aforementioned in-feed shuttle assembly. That is, the material, though too short to be securely held and fed from one side of the saw blade, may have enough useful length to it that the grasping of the material from the opposite side of the saw blade area might salvage some of the material, thus reducing what would otherwise be considered to be waste material.

Accordingly, there is a need to provide an assembly for pulling material away from the saw blade cutting area at the “out-feed” side of the cutting area of the sawing machine, which assembly would be functionally cooperative with the “in-feed” shuttle assembly of current manufacture. There is also a need to fabricate such an assembly using a minimal number of parts and to provide such an assembly that uses a minimal number of steps to operate.

### SUMMARY OF THE INVENTION

It is, therefore, a principal object of this invention to provide a new and useful material puller assembly for use with a sawing machine, including a vertical band saw having tilting capabilities, for pulling material away from the saw blade cutting area at the “out-feed” side of the sawing machine. It is another object of this invention to provide a material puller assembly that functionally cooperates with the “in-feed” shuttle assembly of current manufacture. It is still another object of this invention to fabricate such an assembly using a minimal number of parts. It is yet another object of this invention to provide such an assembly that uses a minimal number of steps to operate.

The material puller assembly of the present invention has obtained these objects. It provides for a material puller assembly for use with a sawing machine, including a vertical band saw, that has a horizontal support means for supporting the material as it is fed from the in-feed shuttle assembly, through the blade cutting area of the sawing machine and toward the material puller assembly. The material puller assembly uses a first horizontal side support member along which movement of a vertically-disposed support means is provided. A second horizontal side support member is included as well.

The vertically-disposed support means includes means for clamping a piece of material between a vertically-movable upper clamp jaw and a vertically-stationary lower clamp jaw. The vertically-disposed support means and the clamp jaws are horizontally movable along the first side support member. Rotatably suspended between the first and second side support members are a number of support rollers. At least one of the support rollers is modified in design such that the profile of the vertically-stationary lower clamp jaw matches an axial contour defined within the roller. In this way, the lower clamp jaw can pass over the roller profile such that a piece of material being moved by the upper and lower clamp jaws is allowed to be supported by the rollers. In the preferred embodiment of the present invention, the profiled roller is disposed closest to the saw blade cutting area and is power-actuated.

The foregoing and other features of the jaw assembly of the present invention will be apparent from the detailed description that follows.

### BRIEF DESCRIPTION OF THE DRAWINGS

FIG. 1 is a rear elevational view of a material puller assembly as used with a sawing machine in the form of a vertical band saw, the band saw being partially shown in phantom view.

FIG. 2 is an enlarged rear, top and right side perspective view of the material puller shown in FIG. 1.

FIG. 3 is a further enlarged rear elevational view of the material puller assembly shown in FIG. 1 and illustrating relative horizontal movement of the vertical clamp support member of the assembly.

FIG. 4 is a top plan view of the material puller assembly as shown in FIG. 3.

FIG. 5 is a bottom plan view of the linear bearing of the material puller assembly and taken along line 5-5 of FIG. 3.

FIG. 6 is a further enlarged right side elevational view of the material puller assembly and taken along line 6-6 of FIG. 4.

FIG. 7 is a top plan view of the top clamp and vertical clamp support member of the material puller assembly and taken along line 7-7 of FIG. 6.

FIG. 8 is a front elevational view of the material puller assembly and taken along line 8-8 of FIG. 4.

FIG. 9 is a further enlarged front elevational view of the top and bottom clamps in the “open” position and showing a length of material disposed between them, taken along line 9-9 of FIG. 4.

FIG. 10 is another front elevational view of the top and bottom clamps illustrated in FIG. 9 and showing the clamps in the “closed” position engaging the length of material disposed between them, taken along line 10-10 of FIG. 4.

FIG. 11 is a right side elevational view of the top and bottom clamps shown in the “open” position and taken along line 1 1-11 of FIG. 4.

### DETAILED DESCRIPTION OF THE PREFERRED EMBODIMENT

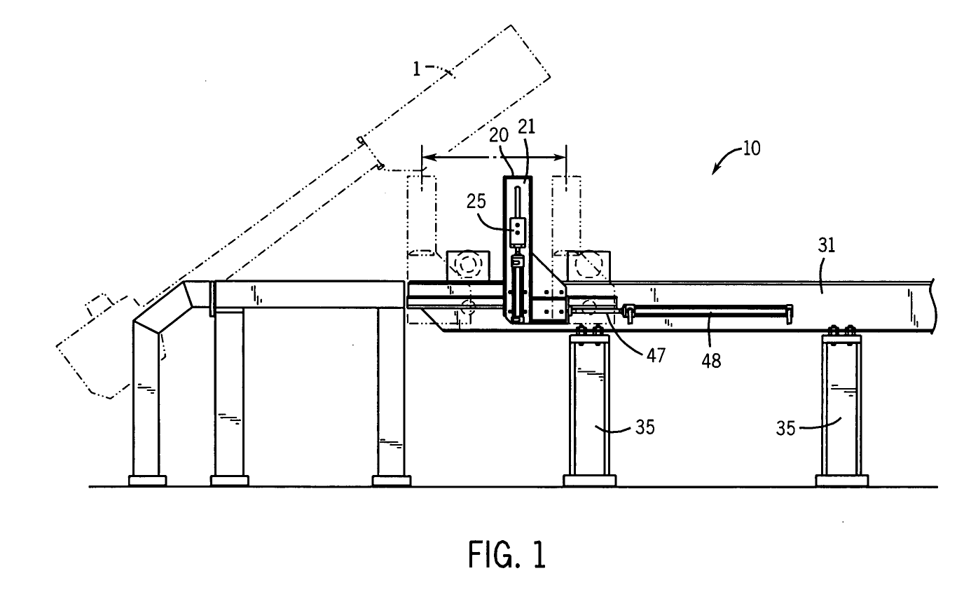

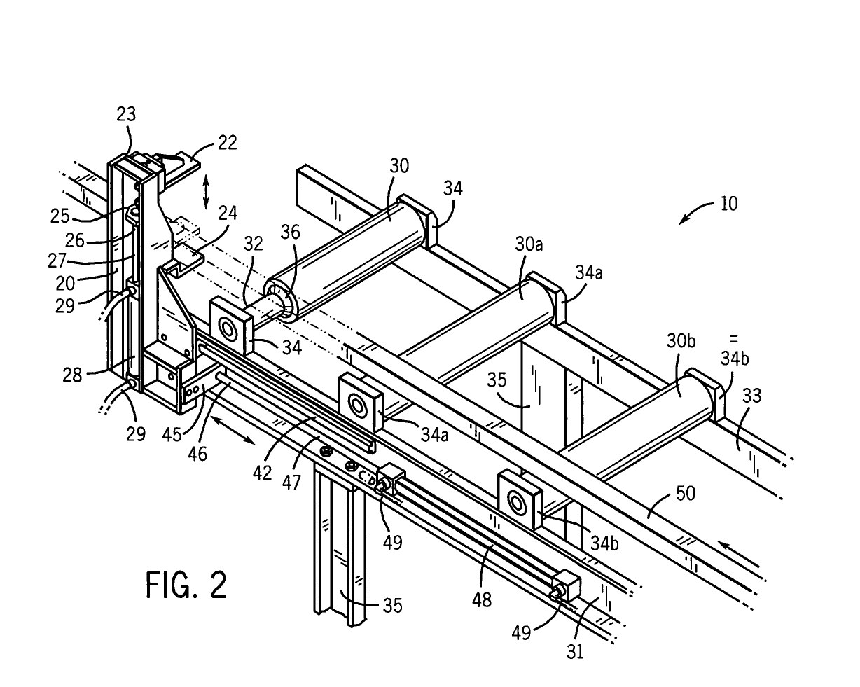

Referring now to the drawings in detail, wherein like numerals represent like structure and elements throughout, FIGS. 1 and 2 illustrate a preferred embodiment of a material puller assembly, generally identified 10, constructed in accordance with the present invention and used with a sawing machine of current manufacture. In the preferred embodiment, and solely for purposes of explaining enablement of the invention, the sawing machine is described herein as a vertical band saw having a wide sweep tilting mechanism. It is to be understood, however, that the material puller 10 of the present invention could be used with other sawing machines without deviating from the scope of the claims herein and the claims herein are not limited by the detailed description that follows.

The band saw and the tilting mechanism itself is shown in phantom view and is generally identified 1. The band saw 1 uses the combination of a tilt arm and a tilt drive in which the tilt arm has a first portion that is slidably connected to a tiltable frame, and a second portion which is pivotably connected to a support. The tilt drive, which may be a cylinder actuator or other drive mechanism, is pivotably mounted to a support and is slidably connected to the tilt arm. The tilt drive is preferably arranged so that the relationship between the degree of movement of the tilting frame and the displacement of the drive is generally linear over the entire sweep, from negative 600 to positive 60° from vertical.

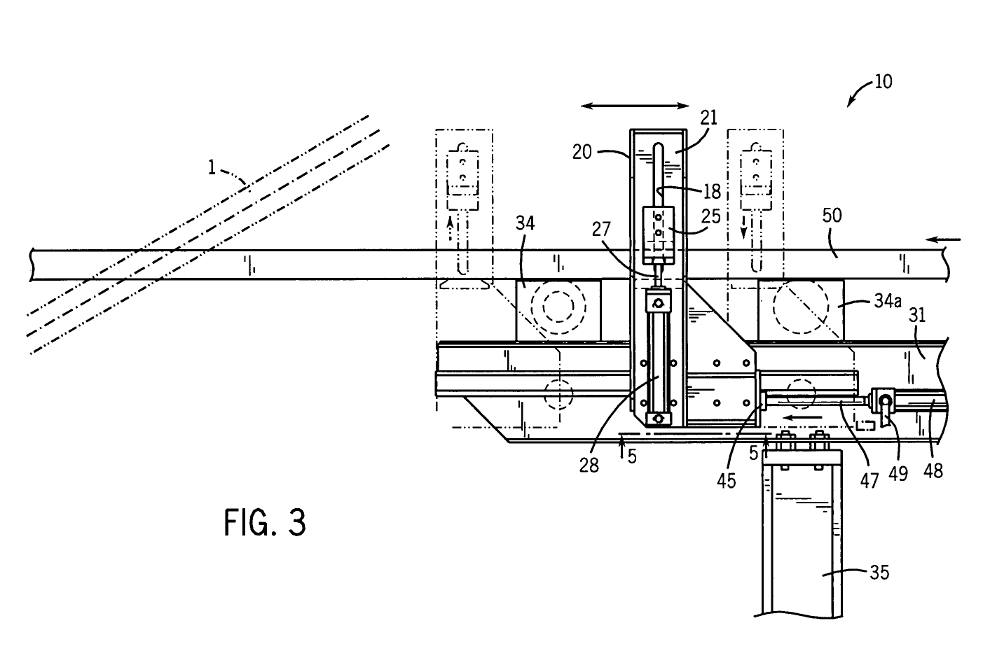

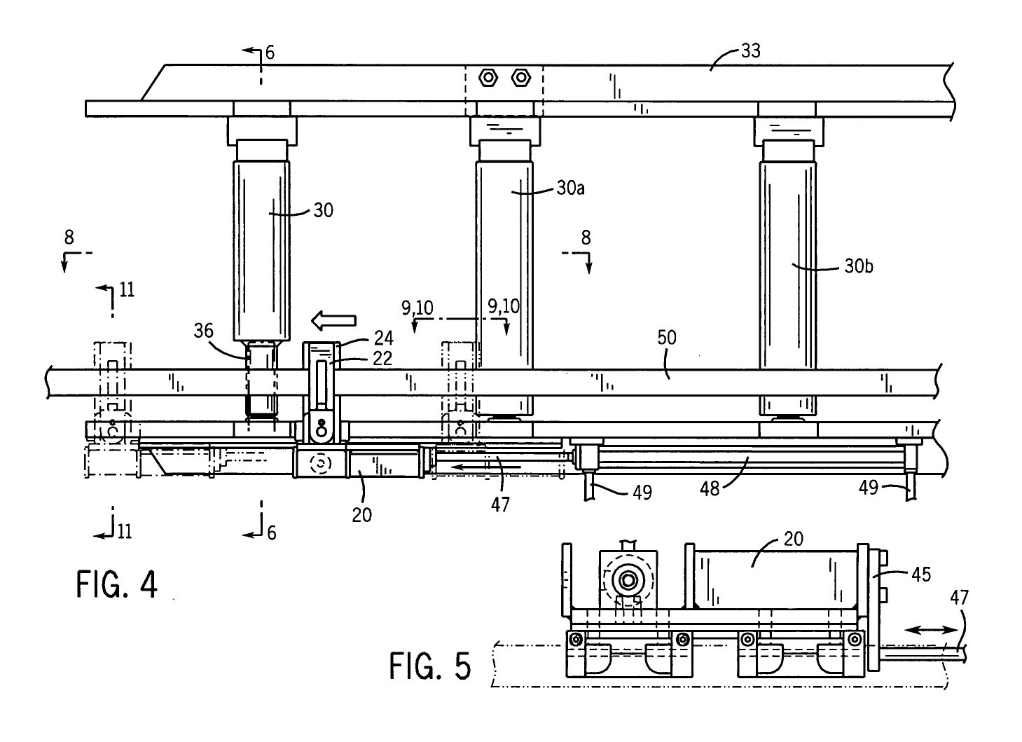

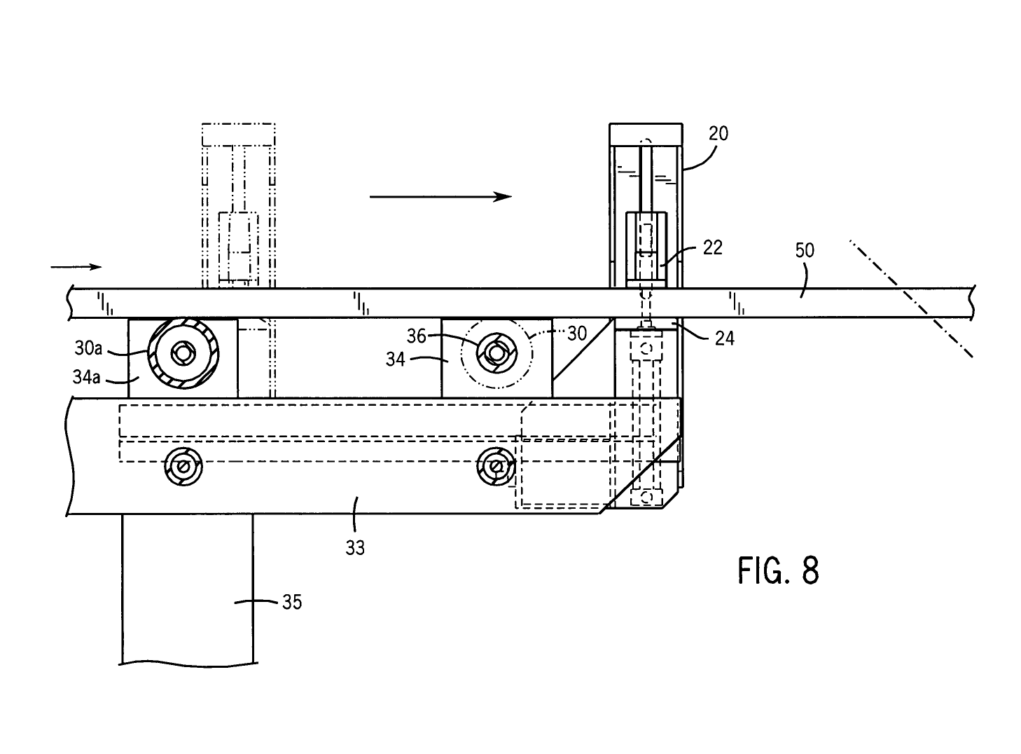

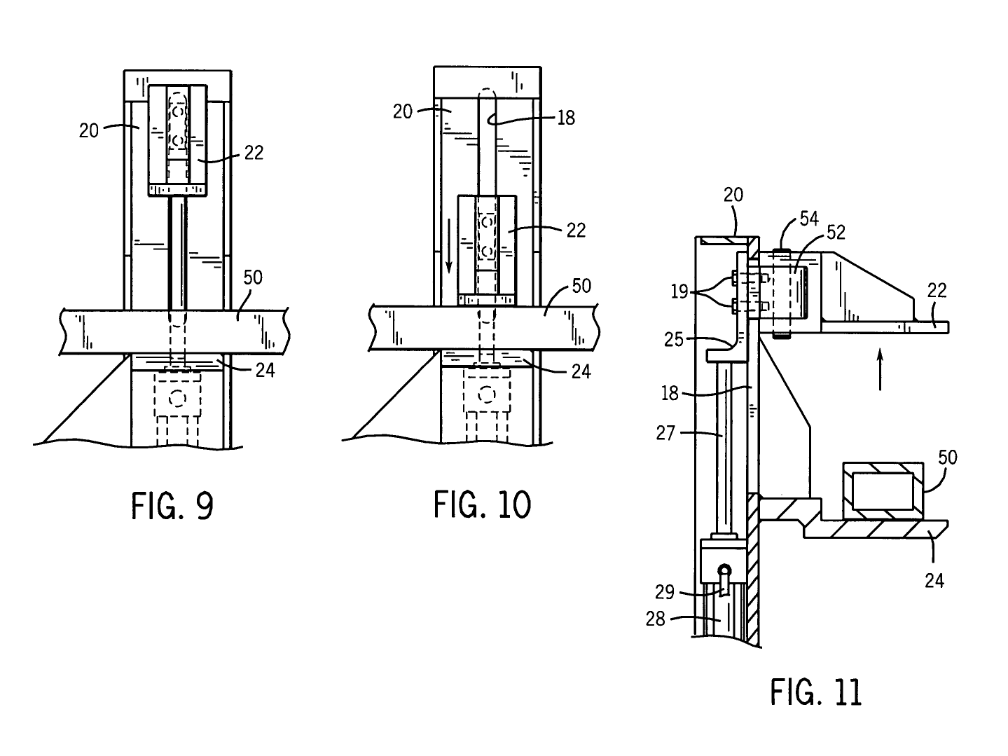

Referring more specifically to FIGS. 2 through 8, it will be seen that the preferred embodiment of the material puller assembly 10 of the present invention is comprised of a vertical clamp support member 20. The vertical clamp support member 20 has a first side 21 and a second side 23. Disposed to the first side 21 of the vertical clamp support member 20 is a hydraulically-actuated cylinder 28. The cylinder 28 includes hydraulic fluid ports 29 for extensibly moving a piston rod 27 in and out of the cylinder 28 and along the first side 21 of the vertical clamp support member 20. The piston rod 27 includes an end 26 that is attached to a slide angle 25. The slide angle 25 is attached to an upper clamp block 52 by means of fasteners 19 that extend through a vertically-disposed slot 18 that is defined within the vertical clamp support member 20. See FIGS. 3, 6, 10 and 11, in particular. The upper clamp jaw 22 is attached to the upper clamp block 52 by means of a pin 54 and is thus vertically movable along the slot 18 with the block 52 and therefore also along the second side 23 of the vertical clamp support member 20. It should be noted that, by virtue of the pin 54 and block 52, the upper clamp jaw 22 is pivotally-movable as is shown in phantom view in FIG. 7. A complementary lower clamp jaw 24 is provided and is also attached to the second side 23 of the vertical clamp support member 20. The lower clamp jaw 24 is, however, stationary relative to the vertical for reasons that will become apparent later in this detailed description. See also FIGS. 9 through 11 in this regard as well.

As shown in FIG. 2, the material puller assembly 10 of the present invention also comprises a plurality of support rollers 30, 30a, 30b that are horizontally and transversely-disposed relative to a pair of opposing horizontal and longitudinally-extending first and second side frame members 31, 33, respectively. The uppermost surface of each of the support rollers 30, 30a, 30b form an imaginary plane over which material may pass and be supported as it passes over the rollers 30, 30a, 30b. The side frame members 31, 33 are, in turn, supported by a plurality of upwardly extending vertical frame members 35. It is to be understood, however, that other support means could be employed without deviating from the scope of the present invention. Each roller 30, 30a, 30b is suspended between and supported by a pair of pillow blocks 34, 34a, 34b. The pillow blocks 34, 34a, 34b are located at each end of the rollers 30, 30a, 30b, respectively, and atop each of the side frame members 31, 33. One of the rollers 30 is uniquely configured at the pillow block 34 that is situated atop the first side frame member 31. That is, the end 32 of the roller 30 nearest the first side frame member 31 includes an axial contour 36 that is defined within it. The purpose and function of this contour 36 will be apparent later in this detailed description.

Referring again to FIGS. 2 and 3, the material puller assembly 10 of the present invention also comprises means for moving the vertical clamp support member 20 longitudinally along the first side frame member 31. More specifically, the first side member 31 includes a linear bearing 42 along which the vertical clamp support member 20 may slide. Horizontal movement of the vertical clamp support member 20 along the linear bearing 42 is accomplished in the preferred embodiment by means of a second hydraulically-actuated cylinder 48. The cylinder 48 includes hydraulic fluid ports 49 for extensibly moving a piston rod 47 in and out of the cylinder 48 along the first side frame member 31. The piston rod 47 includes an end 46 that is attached to an attachment bar 45. The in and out movement of the piston rod 47 thus moves the vertical clamp support member 20 forwardly and backwardly along the first side frame member 31. The attachment bar 45 is secured to the vertical clamp support member 20 in the general area of the linear bearing 42. In the material puller assembly 10 of the present invention, the longitudinal movement, or “stroke,” of the vertical clamp support member 20 is limited by the length of the piston rod 47 and is, in the preferred embodiment, a fixed length of twenty-four inches.

Although the material part puller 10 of the present invention has been described above to include actuation mechanisms in the form of hydraulically-actuated cylinders 28, 48, it is to be understood that the actuation of the material part puller 10 could also be effected by pneumatic actuation and by electrical actuation, or by any combination of them without deviating from the scope of the present invention. Further, the claims herein are not limited by the detailed description herein in that regard.

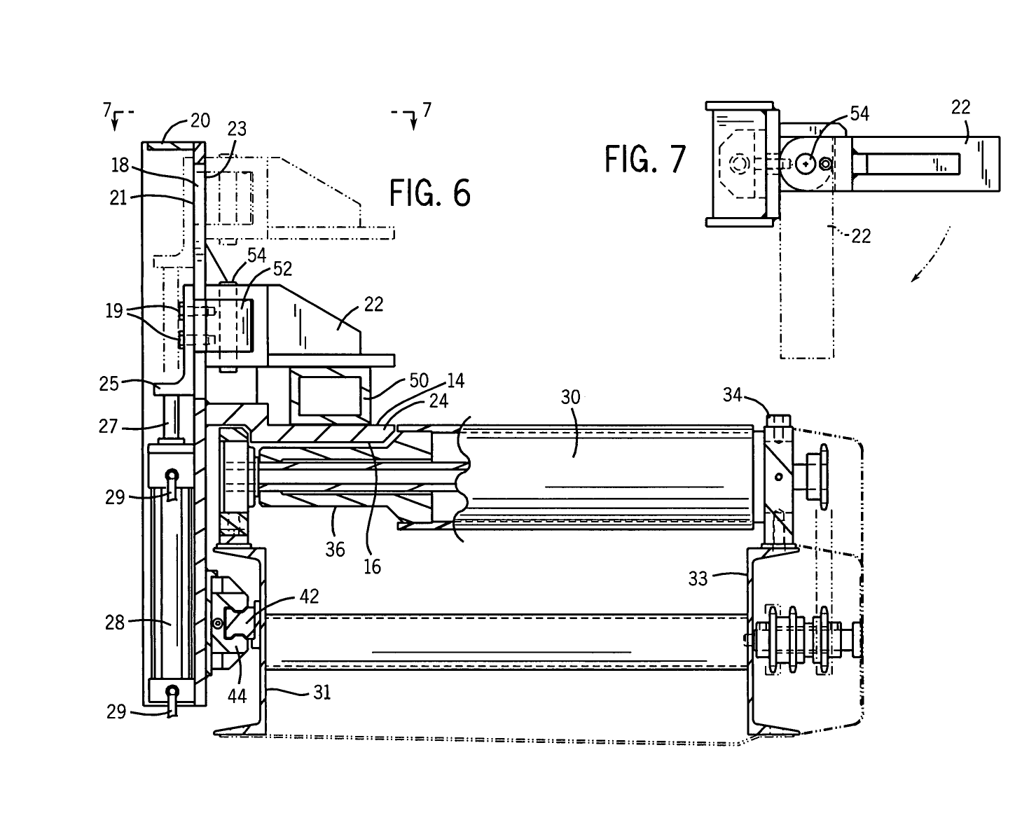

In application, it is preferable that a control means (not shown) is provided for allowing the material puller assembly 10 of the present invention to functionally cooperate with the in-feed shuttle of the band saw 1 and with the vise of the band saw 1 itself. The control means functions in accordance with a pre-programmed scheme for maximizing material usage and minimizing material wastage. As shown in FIG. 2, a piece of stock 50 is supported, in part, by the rollers 30, 30a, 30b. With an insufficient amount of stock 50 at the in-feed portion lo of the band saw 1 to advance the stock 50 towards the blade portion of the band saw 1, the material puller assembly 10 takes over to grasp the stock 50 and move it towards the blade portion of the band saw 1. This is accomplished by the actuation of the first hydraulic cylinder 28 which brings the movable upper clamp jaw 22 downwardly towards the stationary lower clamp jaw 24, thereby clamping a portion of the stock 50 therebetween. See FIG. 9. The second hydraulic cylinder 48 is then actuated to pull the vertical clamp support member 20 away from the saw blade thereby advancing the stock 50 to the desired cut position. A shown in FIG. 6, the bottom contour 16 of the lower jaw 24 is configured to be complementary to the axial contour 36 of the support roller 30. These complementary contours 16, 36 allow the lower jaw 24 to pass over the support roller 30 as the vertical clamp support member 20 is moved longitudinally along the first side frame member 31. This also keeps the upper surface 14 of the lower clamp jaw 24 at the same vertical height as that of a horizontal plane that would be defined by the uppermost surfaces of the rollers 30, 30a, 30b, thus allowing a piece of stock 50 to move across those surfaces when grasped between the upper and lower clamp jaws 22, 24, respectively.

Accordingly, it will be seen that there has been provided a new and useful material puller assembly for use with a sawing machine, including a vertical band saw having tilting capabilities, for pulling material away from the saw blade cutting area at the “out-feed” side of the area; that functionally cooperates with the “in-feed” shuttle assembly of current manufacture; that uses a minimal number of parts and a minimal number of steps to operate.

What is claimed is:

1. A material puller assembly for use with a sawing machine, the sawing machine having a saw blade cutting area, which comprises
a material support means,
a pair of cooperating jaws, the jaws being mounted in a movable vertical support member,
means for moving the vertical support member horizontally along the material support means,
wherein a length of material may be grasped between the jaws and selectively moved towards and away from the saw blade cutting area of the sawing machine.

2. The puller assembly of claim 1 wherein the material support means comprises a plurality of support rollers that are horizontally and transversely-disposed relative to a pair of opposing horizontal and longitudinally-extending side frame members, the uppermost surfaces of the support rollers forming a plane.

3. The puller assembly of claim 2 wherein the pair of cooperating jaws comprises a lower jaw and an upper jaw.

4. The puller assembly of claim 3 wherein the upper jaw is vertically-movable along the vertical support member and wherein the lower jaw is fixed in its vertical position.

5. The puller assembly of claim 4 wherein the lower jaw has an upper surface and a bottom contour and wherein at least one of the support rollers includes a complementary axial contour such that the upper surface of the lower jaw is coplanar with the uppermost surfaces of the support rollers.

6. The puller assembly of claim 5 wherein the upper jaw is vertically-movable by actuation means selected from a group consisting of hydraulic-actuation, pneumatic-actuation and electric-actuation, or a combination thereof.

7. A puller assembly of claim 5 wherein the vertical clamp support member is horizontally-movable by actuation means selected from a group consisting of hydraulic-actuation, pneumatic-actuation and electric-actuation, or a combination thereof.

8. The puller assembly of claim 1 which further comprises control means for actuating the puller assembly in accordance with a pre-programmed scheme.

9. A material puller assembly for use with a sawing machine, the sawing machine having a saw blade cutting area, an in-feed area, an in-feed mechanism, and an out-feed area, the material puller assembly being located at the out-feed area of the sawing machine, which comprises
means for supporting a length of material at the out-feed area of the sawing machine,
a pair of cooperating jaws, said jaws including an upper jaw and a lower jaw
a movable jaw support member, said jaw support member being configured to allow for selective vertical movement of the upper jaw, and
means for selectively moving the jaw support member horizontally along the material support means,
wherein a length of material may be grasped between the jaws and selectively moved towards and away from the saw blade cutting area of the sawing machine.

10. The material puller assembly of claim 9 wherein the material support means comprises a plurality of support rollers that are horizontally and transversely-disposed relative to a pair of opposing horizontal and longitudinally-extending side frame members, the uppermost surfaces of the support rollers forming a plane thereby.

11. The material puller assembly of claim 10 wherein the lower jaw has an upper surface and a bottom contour and wherein at least one of the support rollers includes a complementary axial contour such that the upper surface of the lower jaw is coplanar with the uppermost surfaces of the support rollers.

12. The material puller assembly of claim 10 wherein the upper jaw is selectively vertically-movable by actuation means selected from a group consisting of hydraulic-actuation, pneumatic-actuation and electric-actuation, or a combination thereof.

13. The material puller assembly of claim 10 wherein the movable jaw support member is selectively horizontally-movable by hydraulic-actuation means selected from a group consisting of actuation, pneumatic-actuation and electric-actuation, or a combination thereof.

14. The material puller assembly of claim 10 which further comprises control means for actuating the movable upper jaw and the movable jaw support member of the puller assembly in accordance with a pre-programmed scheme.

15. A material puller assembly for use with a sawing machine having power tilt capabilities, the sawing machine having a saw blade cutting area, an in-feed area, an in-feed shuttle mechanism, and an out-feed area, the material puller assembly being located at the out-feed area of the power tilting sawing machine, which comprises
means for supporting a length of material in a substantially horizontal position at the out-feed area of the sawing machine,
a pair of cooperating jaws, said cooperating jaws including a vertically-movable upper jaw and a vertically-fixed lower jaw,
a horizontally-movable jaw support member, said jaw support member being configured to allow for the selective vertical movement of the upper jaw along the jaw support member, said jaw support member being movable along a portion of the material support means,
means for selectively moving the jaw support member horizontally along the material support means,
wherein a length of material may be grasped between the cooperating jaws and selectively moved towards and away from the saw blade cutting area of the sawing machine.

16. The material puller assembly of claim 15 wherein the material support means comprises a plurality of support rollers that are horizontally and transversely-disposed relative to a pair of opposing horizontal and longitudinally-extending side frame members, the uppermost surfaces of the support rollers forming a plane thereby.

17. The material puller assembly of claim 15 wherein the lower jaw has an upper surface and a bottom contour and wherein at least one of the support rollers includes a complementary axial contour such that the upper surface of the lower jaw is coplanar with the uppermost surfaces of the support rollers.

18. The material puller assembly of claim 15 wherein the upper jaw is selectively vertically-movable by actuation means selected from a group consisting of hydraulic-actuation, pneumatic-actuation and electric-actuation, or a combination thereof.

19. The material puller assembly of claim 15 wherein the horizontally-movable jaw support member is selectively movable by actuation means selected from a group consisting of hydraulic-actuation, pneumatic-actuation and electric-actuation, or a combination thereof.

20. The material puller assembly of claim 15 which further comprises control means for actuating the vertically-movable upper jaw and the horizontally-movable jaw support member in accordance with a pre-programmed scheme that coordinates movement with the in-feed shuttle mechanism.
